(19) United States
(12) Patent Application Publication
(10) Pub. No.: US 2010/0125111 A1
(43) Pub. Date: May 20, 2010

(54) COMPOSITIONS AND METHODS FOR RESISTING SOIL EROSION AND FIRE RETARDATION

(76) Inventor: SCOTT HARRISON, Bakersfield, CA (US)

Correspondence Address: STETINA BRUNDA GARRED & BRUCKER, 75 ENTERPRISE, SUITE 250, ALISO VIEJO, CA, 92656, US

(21) Appl. No.: 12/694,500

(22) Filed: Jan. 27, 2010

Related U.S. Application Data
(63) Continuation-in-part of application No. 12/117,574, filed on May 8, 2008, now Pat. No. 7,666,923.
Application No. 12/117,574 is a continuation-in-part of application No. 10/971,654, filed on Oct. 22, 2004, now Pat. No. 7,407,993.
Application No. 10/971,654 is a continuation-in-part of application No. 10/368,904, filed on Feb. 18, 2003, now Pat. No. 6,835,761.
Application No. 10/368,904 is a continuation of application No. 09/897,093, filed on Jun. 29, 2001, now Pat. No. 6,562,882.

(51) Int. Cl. C09K 17/22

(52) U.S. Cl. 523/132

(57) ABSTRACT

Compositions and methods for resisting soil erosion. The compositions comprise a polymer mixed with an organic material. The polymer preferably comprises polyacrylamide or an acrylamide copolymer having anionic functional groups. A second polymer to promote the formation of a film may also be utilized. The organic material comprises natural and synthetic fiber material. The methods of the present invention comprises applying the compositions of the present invention to an area of land sought to be provided with soil erosion resistant properties and thereafter allowing water to mix therewith, as may be supplied or provided naturally by precipitation.

### CROSS-REFERENCE TO RELATED APPLICATIONS

The present application is a continuation-in-part of U.S. patent application Ser. No. 12/117,574, filed May 8, 2008, entitled COMPOSITIONS AND METHODS FOR RESISTING SOIL EROSION AND FIRE RETARDATION, now in the issuance process, which is a continuation-in-part of U.S. patent application Ser. No. 10/971,654, filed Oct. 22, 2004, entitled COMPOSITIONS AND METHODS FOR RESISTING SOIL EROSION AND FIRE RETARDATION, now issued as U.S. Pat. No. 7,407,993 which is a continuation-in-part of U.S. patent application Ser. No. 10/368,904 filed Feb. 18, 2003, entitled SOIL FORMULATION FOR RESISTING EROSION, now issued as U.S. Pat. No. 6,835,761 which is a continuation of U.S. patent application Ser. No. 09/897,093, filed Jun. 29, 2001, entitled SOIL FORMULATION FOR RESISTING EROSION AND SETTLEMENT CONTROL now issued as U.S. Pat. No. 6, 562,882, the teachings of all of which are expressly incorporated herein by reference.

### STATEMENT RE: FEDERALLY SPONSORED RESEARCH/DEVELOPMENT

Not Applicable

### BACKGROUND OF THE INVENTION

Soil erosion, namely, the detachment of particles of soil and surficial sediments and rocks, is a serious problem recognized worldwide. Essentially, erosion occurs via the forces of wind and water that facilitate the movement of topsoil from one place to another. Of such forces, water erosion is generally considered more detrimental to soils both by the volume of soil removed, and the area of land influenced. Moreover, although soil erosion can potentially occur in any land surface, sloping areas mantled with soil or loose sediment are particularly susceptible to such forces and are exceptionally vulnerable to the extent the same lack any type of vegetation, as occurs during grading or when such areas have been attacked by wildfires. Indeed, current data seems to suggest that in the United States, soil has recently been eroded at about seventeen times the rate at which it forms. Further data suggests that soil erosion rates in Asia, Africa and South America are about twice as high as that in the United States.

Due to its significance, several attempts have been made to prevent or substantially reduce soil erosion. Among the more well-known of such methods include agricultural practices, such as contour farming and terracing, no-till cultivation, strip farming and poly-varietal cultivation. Other well-known approaches include adding organic matter to soil which, by biochemical degradation, produces polysaccharides that are cohesive in nature and act to cause soil particles to stick together and resist erosion. Along these lines, products have been introduced to provide at least temporary erosion control, particularly with respect to slopes and the like until such time as trees and vegetation can take root to resist erosion. Such products include bonded fiber matrices, such as Soil Guard® produced by Mat Inc., of Floodwood, Minn., which comprises a continuous layer of elongated fiber strands held together by a water-resistant bonding agent. Such product is operative to eliminate direct raindrop impact on soil and further includes high water-holding capacity that eventually biodegrades into plant nutrients.

Such products, however, are of limited effectiveness and often do not provide the degree of soil erosion resistance as is typically desired, particularly for use in relation to man-made slopes and terraces in arid regions, such as southern California and Arizona. Such lack of effectiveness can and does often affect residential and commercial property development where man-made slopes are developed to support such structures and the like. In this regard, inadequate soil erosion resistance can culminate in the destruction of condemnation of buildings and dwellings, as well as create substantial storm water pollution. Moreover, such matrices can inhibit new plant growth by acting as a barrier against proper germination.

Likewise not heretofore addressed by the prior art is the risk posed to slopes, hillsides, and the like whose vegetation has been substantially eradicated by wildfires. In this regard, the vegetation that would normally be present upon such hillsides and slopes typically act as a barrier to resist soil erosion; however, in the absence of such vegetation such earthen structures quickly erode, as discussed above. Indeed, wildfires in Southern California and Colorado evidence the extensive damage that can occur to exposed mountains and hillsides following exposure to a wildfire and even the best management practices for resisting erosion can only afford a moderate degree of protection.

To address such shortcomings, Applicant has previously developed a new class of soil erosion control products, known as stabilized fiber matrix, that relies upon a mixture of water, fiber (i.e., fibrous material, typically cellulose-based), and a linear, water soluble co-polymer of acrylamide and acrylate previously disclosed and claimed by Applicant's previously issued patents, namely, U.S. Pat. Nos. 6,562,882; 6,835,761; 7,407,993; and soon to be issued U.S. patent application Ser. No. 10/971,654, the teachings of which are expressly incorporated herein by reference. Applicant's stabilized fiber matrix technology, however, typically involves a forming a mixture of the water, polymer and fiber components and thereafter applying the components to the area of land sought to be protected. As a consequence, such erosion control technology, although exceptionally effective, requires the need to have water on site to thus form the stabilized fiber matrix and further, typically requires tankers, hydro-seeders and the like to facilitate application to the area of land sought to be protected.

In certain applications, however, it is not practical or is cost prohibitive to apply stabilized fiber matrix. Instead, an ideal alternative would be to be able to place an erosion control barrier that offered the same or similar type of erosion control protection as offered by a stabilized fiber matrix but yet omit the need to provide water, form the stabilized matrix and thereafter apply the same.

Accordingly, there is a substantial need in the art for compositions and methods for resisting soil erosion to a much greater degree than prior art compositions and methods that is further operative to provide a degree of soil erosion control that is similar to Applicant's stabilized fiber matrix but yet omits the need to provide water, form a mixture and thereafter apply a stabilized fiber matrix to an area of land. There is especially a need in the art for such a composition and method for controlling erosion that can essentially be applied as a dry formulation and thus in some applications is easier to transport and apply than prior art soil erosion control techniques. There is further need in the art for such compositions and methods that are non-toxic, biodegradable, and can be readily deployed utilizing existing, commercially-available application techniques. Still further, there is a need in the art for such a composition and method that is of simple formulation, relatively inexpensive to produce, and utilizes known, commercially-available materials.

### BRIEF SUMMARY OF THE INVENTION

The present invention specifically addresses and alleviates the above-identified deficiencies in the art. In this regard, the present invention is directed to compositions and methods that deploy an organic fiber base, which may be formed as a mat, roll, tube, blanket, bale or any of a variety of shapes, sizes and thicknesses that may be desirable, or alternatively may be formed as freely dispersible fibers that, once applied to an area of land, reacts with water to create a stabilized fiber matrix. According to the preferred embodiment, the composition comprises an organic material, which may comprise either natural and/or synthetic fiber materials and a polymer, the latter of which preferably comprises polyacrylamide or a copolymer of polyacrylamide having anionic functional groups, the latter preferably consisting of sodium acrylate. Alternatively, the polymer may comprise a mixture of a polyacrylamide polymer or co-polymer and a second polymer mixed therewith, the latter being either polyethylene glycol or a cellulose ether-type polymer. With respect to the cellulose polymer, the same may take the form of either methylcellulose or hydroxypropylmethylcellulose (HPMC). Glycerin may also be added.

The soil erosion composition may further be provided in the form of an organic material mixed with polyacrylamide or co-polymer or polyacrylamide on site. Such composition is formulated such that the polymer, copolymer or mixture of polymers is present in an amount ranging from 0.25 to 5% by weight of said composition and said organic base comprises the remaining 95.00 to 99.75% of the composition weight. Preferably, the polymer or copolymer is present in an amount ranging from 1.25% to 3.5% by weight and said organic base comprises 98.75% to 96.5% of the composition weight. In further refinements of the invention, the polyacrylamide polymer component may comprise EarthGuard® soil-erosion resistant product produced by Terra Novo, Inc. of Bakersfield, California.

As for the methods of the present invention, the same essentially comprise providing a composition of the aforementioned variety and applying such composition to an area of land sought to be treated to consequently resist soil erosion and allowing the same to be hydrated or react with water, which may be provided such as through irrigation type practices or naturally, such as through rainfall or other precipitation. Advantageously, the composition of the present invention is effective immediately upon application and is non-toxic and biodegradable. Additionally, such methods can be practiced in any kind of weather and on any kind of soil, and is especially well-suited for use on slopes and the like. Moreover, because the formulation of the composition takes the form of dry fibers, composition and methods are easier to transport and apply and further do not require mixing or application with water to impart resistance to soil erosion.

It is therefore an object of the present invention to provide compositions and methods for resisting soil erosion that can resist soil erosion to a far greater degree than prior art compositions and methods, particularly in relation to slopes and the like that further can be applied in a dry formulation and/or prepared on site without mixing with water.

Another object of the present invention is to provide compositions and methods for resisting soil erosion that is non-toxic, biodegradable and safe for the environment.

Another object of the present invention is to provide compositions and methods for resisting soil erosion that is of simple formulation, relatively inexpensive, and can be readily applied utilizing conventional application equipment and techniques.

Still further objects of the invention are to provide compositions and methods for resisting soil erosion that are effective immediately upon application, can be applied in any type of weather, and can be utilized on virtually any type of soil.

### DETAILED DESCRIPTION OF THE INVENTION

The detailed description as set forth below in connection with the appended drawings is intended as a description of the presently preferred embodiments of the invention, and is not intended to represent the only form in which the present invention may be constructed or utilized. The description sets forth the functions and sequences of steps for constructing and operating the invention in connection with the illustrated embodiments. It is understood, however, that the same or equivalent functions and sequences may be accomplished by different embodiments and that they are also intended to be encompassed within the scope of this invention.

The present invention is directed to compositions and methods for achieving the purpose of preventing or substantially reducing soil erosion that are substantially easier to formulate and deploy, and further do not require mixing or application with water but ultimately can combine with water to essentially create a stabilized fiber matrix. With regard to the compositions, there is provided the combination of a polymer component and an organic material with the latter being formed as a mat, blanket, bale of any desired shape or loose organic fiber having the polymer component sprayed or impregnated therein.

The polymer component may comprise polyacrylamide. Such polymer, which is well-known in the art, comprises CH2:CHCONH2 linear polymers polymeric through the vinyl groups. Preferably, the polymer element is formulated as a copolymer of polyacrylamide having anionic functional groups, the latter preferably consisting of sodium acrylate monomers. It should be understood, however, that copolymers of polyacrylamide that include cationic and non-anionic functional groups are contemplated as falling within the scope of the present invention. In a more highly refined embodiment, the polymer component comprises a copolymer of acrylamide and sodium acrylate that is commercially available and sold under the trademark EarthGuard® by Terra Novo, Inc. of Bakersfield, Calif. Such commercial formulation utilizes a copolymer of acrylamide and sodium acrylate present in a ratio of approximately 70:30; however, different ratios of acrylamide:sodium acrylate should also be deemed to fall within the scope of the present invention.

In alternative embodiments, the polymer component may be a mixture of linear polyacrylamide or a linear acrylamide copolymer, on one hand, and a second polymer component operative to promote the formation of a flexible film, discussed more fully below. With respect to such polymer component, the same may comprise polyethylene glycol, or a water soluble cellulose ether. With respect to the latter, the same may take the form of those soluble cellulose ethers as disclosed in U.S. Pat. No. 4,071,400, issued Jan. 31, 1978 entitled METHOD FOR CONTROLLING SOIL EROSION, the teachings of which are expressly incorporated herein by reference. The cellulose ether is commercially available and may take one of two basic forms, namely: 1) methylcellulose; or 2) hydroxypropylmethylcellulose (HPMC). The polymer may yet further optionally include glycerin.

As to the organic material, the same preferably comprises any fibrous material well-known in the art and operative to impart a fiber matrix suitable for use in erosion control applications. Exemplary of such organic materials include straw, jute, wood, excelsior, coconut, nylon, polypropylene, polyolephan, polyester, and/or any other natural or synthetic materials known in the art, including combinations thereof. Such organic materials may further be formed as mats, rolls, blankets, tubes, bales or freely dispersible fibers or loose mulch, and may further be formed per conventional erosion control devices and the like to include netting and the like. Exemplary of such forms the organic material may take include rolled erosion control products, including mulch-control nets, open-weave textiles, erosion control blankets and turf reinforcement mats and may be manufactured from wood fibers, straw, jute, coir, polyolephans, PVC, nylon and combinations thereof.

As will be readily appreciated by those skilled in the art, the organic material choice, depending on its biodegradability and/or natural/synthetic nature, will be indicative of the duration such organic material will be operative to provide erosion control protection. Along these lines, per Applicant's earlier teachings, the organic material may also include materials such as recycled paper mulch and/or wood fiber mulch, among several other organic materials, including cellulose fibers, and the like.

Similarly, depending upon how the organic material is fashioned will likewise dictate the degree of erosion control to be imparted. For example, to the extent the organic material is fashioned as a mulch-control net, which typically consists of two-dimensional, woven natural fibers or geo-synthetic biaxially-oriented processed nettings used for anchoring loose fiber mulches, the same will be ideally suited for moderate soil erosion control. Likewise, to the extent the organic material is fashioned as an open-weave textile, having a generally woven construction, the same may be utilized where higher erosion control protection is required, such as on steep slopes or for reinforcing underlay for sod. Still further, to the extent the organic material is fashioned as an erosion control blanket whereby organic/synthetic fibers are woven, glued or structurally bound with nettings or meshes into a fused matrix, the same may be utilized per conventional practice on sites requiring greater, more durable and/or longer lasting erosion protection, including gradual to steep slopes, low to moderate flow channels, and low-impact shore linings. As will also be appreciated by those skilled in the art, to the extent the organic material is fashioned as a turf reinforcement mat, which will be understood are typically comprised of synthetic fibers and filaments processed into permanent, high-strength three dimensional matrices, will be applied where it is desired for permanent soil erosion control protection and/or critical hydraulic applications, such as drainage channels.

Similarly, the organic material may be fashioned as a slope interruption device and be designed to be installed perpendicular to the downward flow of water on a slope or hillside. Such interruption devices, which may take the form of tubes and rolls, are operative to slow down the water flow and spread out the sheet flow of water as the same runs down a slope. Slope interruption devices are further operative to act as a filter by trapping sediment therewithin.

The basic aforementioned components that comprise the invention, by percent weight with regard to the reconstitutable mixture, encompass the following ranges:

| COMPONENT | PERCENT BY WEIGHT |
|---|---|
| Polymer | 0.25% to 5.00% |
| Organic Material | 99.75% to 95.00% |

It is understood that the percentages of the two components above will total 100% by weight and if other materials are included in the concentrate formulation, the percentages of all ingredients will total 100% by weight.

With respect to combining the polymer component with the organic material, such combination can be accomplished by a variety of methods, and may either be combined such that the polymer component is pre-applied to the organic material at a manufacturing site with resultant fibers with polymer component thereon being suitable for transport and direct application, and discussed more fully below. Alternatively, the organic material may have the polymer component applied thereon on-site where the erosion control is to be provided. Among the various techniques that may be used to combine the polymer component with the organic material include spraying the organic material with the polymer component, dipping the organic material into a polymer “bath”, sprinkling the organic material with the polymer component or combining a polymer-based gel log or polymer tablets directly within the fiber matrix of the organic material. If a spraying technique is utilized, it will be appreciated by those skilled in the art that the polymer component can be in the form of an emulsion, dispersion or dilution. With respect to the latter, the dilution would best be less than 1% of the polyacrylamide polymer or acrylamide copolymer, as dependent upon the ability of the spray equipment to handle the viscosity of the dilution. Preferably, the dilution would be approximately 0.5% of the polyacrylamide polymer or acrylamide copolymer, or less. In any application, however, the resultant composition of organic material and the polymer component will include approximately 25-30 pounds of polyacrylamide polymer or acrylamide copolymer per acre to which the resultant combination of organic material and polymer component are applied.

As discussed above, in certain aspects of the invention, the polymer component may include a combination of polymers. With respect to the combination of polymer components, the same will preferably include the polyacrylamide polymer or acrylamide copolymer, and a further polymer such as polyethylene glycol or cellulose ether, namely, methylcellulose or hydroxypropylmethylcellulose, as discussed above. With respect to the relative amounts of such components, the polyacrylamide polymer/acrylamide co-polymer is preferably present anywhere from 10-90% of the total polymer weight applied to the organic material. Conversely, the second polymer utilized to promote the formation of a flexible film, namely, either the polyethylene glycol or cellulose ether, will be present in the remaining 10-90% of the total weight of the polymer applied to the organic material such that the combined weight of the polymer components will total 100% of the polymer component weight.

In further refinements of the invention, the polymer component may further include glycerin. Preferably, the glycerin is added as a component of the second polymer, and may be added as much as 20% of the total weight of the second polymer component; however, for a less rubbery, faster drying film with higher tensile strength, the glycerin may be used in lesser amounts. In an exemplary embodiment, the polymer component may include 3 parts of the polyacrylamide polymer/acrylamide co-polymer, 1 part hydroxypropylmethylcellulose and 0.2 parts glycerin. Such illustrative embodiment, which is in no way intended to be limiting to the scope of the present invention, provides ideal characteristics for the practice of the present invention.

When the aforementioned polymer components are combined, it will be appreciated by those skilled in the art that certain considerations may need to be made insofar as it has been discovered by Applicant that the combination of the polyacrylamide polymer/acrylamide copolymer, on one hand, and the second polymer component for promoting a flexible film, namely, polyethylene glycol or cellulose ether, on the other hand, if not mixed respectively, in compatible oils or emulsions will interact very quickly to form a gel or film when combined with one another and mixed with water. In this respect, it has been discovered that such polymer components are ill-suited to be premixed in a solution and stored because the interaction between such polymer components causes the same to quickly gel. As presently contemplated, it may be necessary for the polymer components to be kept separate from one another and mixed very quickly before application to the organic material. To accomplish that end, it is contemplated that spraying apparatus will have to be utilized wherein the separate polymer components are provided in tanks having leads joined to a union inline mixer that enables the polymer components to be mixed just prior to spraying. Along these lines, it is contemplated that the separate components should preferably be mixed and applied to the polymer component within 30 seconds. It is further contemplated that such immediate mixing and subsequent spraying should be practiced whether or not the organic material is coated with the polymer component either by a remote manufacturing processes or by an on-site application process. This objective may be achieved by a variety of commercially available pumps, spray bars, in-line mixers that are commercially available and well-suited for the practice of the present invention, and can include venturi-type pressure differential injectors. Exemplary of such devices include high-performance venturi-type injectors produced by Mazzei Injector Company, LLC of Bakersfield, Calif.

Alternatively, to the extent the polymer components, namely, the polyacrylamide polymer/acrylamide copolymer and second polymer component for promoting a flexible film are suspended within compatible oils or emulsions, it is contemplated that such polymer components could be combined to make a single mixture that may be manufactured, stored and applied as desired without the aforementioned requirements discussed above regarding rapid mixing and application. Moreover, such combination of polymers could further include the glycerin component to thus produce one single chemical blend of all three polymer components, for example an acrylamide copolymer, hydroxypropylmethylcellulose and glycerin.

In a more highly refined embodiment, the composition comprises the mixture of a polymer present in an amount of approximately between 1.25% to 3.5% by weight and the organic material in an amount between 98.75% to 96.5% by weight. In a most preferred embodiment, the polymer component is present in an amount from between 1.25% to 2.00% by weight of the composition. Again, to the extent additional materials are included, the percentages of all ingredients will total 100% by weight.

For application, the polymer/organic composition will be positioned about the area of land to be protected. In this regard, to the extent the polymer/organic composition is formed as a mat, blanket and the like, the same may merely be positioned over the area sought to be protected from erosion. For example, to the extent the polymer/organic composition is formed as a mulch-control net, the same may be rolled out over the area of land sought to be protected and stapled or staked into place, as per conventional practices. Similarly, when fashioned as a turf reinforcement mat, the same may be installed by rolling out and fastening the turf reinforcement mat with long-lasting staples or stakes to the soil surface. Any geometric size or shape of the fiber matrix of the organic material is contemplated. Similarly, it is contemplated that the polymer component or polymer components, as discussed above, may be sprayed upon or applied to the organic material prior to installing the organic material onto the area of land sought to be protected or, alternatively, the organic material may first be placed into position upon the area of land sought to be protected and the polymer component or components thereafter applied thereto in the aforementioned manner.

Advantageously, the present invention, by providing the combination of organic material and polymer component(s) are operative to provide substantially greater protection than conventional mats, blankets and the like formed exclusively of organic material insofar as the latter prior art devices or operative to just lay over the soil and do not interact with the soil. By virtue of just laying over the soil sought to be protected, water is operative to penetrate therethrough or flow under the organic material and still cause erosion of the soil to occur. By including the polymer component, especially the polyacrylamide polymer/acrylamide copolymer, the same will eventually leave the organic material to which the same was applied and ultimately go into the soil when contacted with sufficient water, thus allowing the polymer component to interact with the soil and provide a greater degree of erosion control protection. As a direct benefit of the present invention, not only is erosion control enhanced, but cleaner runoff water is produced insofar as the sediment remains in place, as opposed to carried away by the excess water flow.

Alternatively, the polymer/organic composition, when formed as a loose mulch, may merely be spread about the area of land sought to be protected from erosion forces per conventional application procedures, such as by dull-bladed coulter disks. To that end, and as discussed above, it is expressly contemplated that the polymer/organic composition may be formed remotely, at a manufacturing facility, where the organic component is applied or impregnated with the polymer component and thereafter transferred on site for application.

In order to impart the soil erosion control protection, it will be appreciated that erosion control protection will ultimately come about via hydration, namely, contact with water. In this regard, it is contemplated that the water component may either be applied upon application of the polymer/organic composition, as may be accomplished through conventional irrigation techniques and/or application by tanker, aerial drop and the like or, alternatively, may be achieved by natural precipitation, such as rainfall, that ultimately interact with the polymer/organic composition to ultimately form a stabilized fiber matrix. In this regard, and contrary to conventional stabilized fiber matrix compositions, the compositions of the present invention do not require mixing with water in order to generate the stabilized fiber matrix composition and subsequent application. Instead, the polymer/organic composition is merely applied without the water component and allowed to ultimately react with water as may be best suited for a particular application. Along those lines, the amount of water for hydration is not crucial. Accordingly, the compositions and methods of the present invention are not necessarily dependent upon tanker trucks or hydro-seeders for application.

As discussed above, the formulation of the polymer/organic composition may be selectively chosen to impart either a shorter or longer degree of erosion control protection. To impart temporary or seasonal erosion control protection, the organic material preferably comprises cellulose fiber derived from a natural source, such as wood chips, straw, coconut or any of the aforementioned natural materials. Conversely, to the extent a longer degree of erosion control protection is sought, the organic material will be selected from synthetic, non-biodegradable polymer materials, such as nylon, propylene or other synthetic materials referenced above. It is likewise contemplated that the organic material may comprise mixtures of both synthetic and natural materials as may be desired for a particular application. Although the specific configuration of the organic component and amount of the polymer/organic material compositions of the present invention to be applied can be readily determined by those skilled in the art, it is contemplated that generally such compositions should be applied at a rate of between 3,000 pounds to 4,500 pounds per acre of land. Moreover, it is contemplated that the polymer component will typically comprise about 25 to 30 pounds of the overall polymer/organic composition. As will be appreciated, however, greater or lesser amounts may be utilized for specific applications.

Advantageously, the compositions of the present invention are non-toxic, biodegradable and can be applied to any types of soils in any type of weather conditions. Moreover, by simply using well-known and commercially available materials, in particular the polymer component of the present invention, the compositions and methods of using the same according to the present invention are substantially more cost effective than prior art compositions and methods.

Additional modifications and improvements of the present invention may also be apparent to those of ordinary skill in the art. For example, it will be understood that the organic material may be selected such that the same is comprised of a fibrous material wherein the fibers will be selectively chosen to be either natural or synthetic in nature, and have a sufficiently long length as may be desired for a particular application. For example, when formed as a loose mulch, the organic material may have a fiber length of at least 10-20 centimeters, which is recognized as the minimum length necessary to form a loose mulch. Likewise, when formed as a turf reinforcement mat, synthetic fibers may be chosen that are UV-stabilized and possess sufficient tensile characteristics to function as a matrix for entangling plant roots, stems, soils and the like. Thus, the particular combination of parts and steps described and illustrated herein is intended to represent only certain embodiments of the present invention, and is not intended to serve as limitations of alternative devices and methods within the spirit and scope of the invention.

What is claimed is:

1. A composition for reducing soil erosion from an area of land comprising: a polymer component comprising a copolymer of linear polyacrylamide and sodium acrylate;
an organic material;
and wherein the polymer component is present in an amount between 0.25% to 5.00% by weight of the combined weight of said polymer component and said organic material.

2. The composition of claim 1 wherein said organic material is selected from the group consisting of cellulose, mulch, straw, coconut and excelsior.

3. The composition of claim 2 wherein said mulch is selected from the group consisting of paper mulch and wood fiber mulch.

4. The composition of claim 1 wherein the polymer component is present in an amount between 1.25% to 3.5% by weight of the combined weight of said polymer component and said organic material.

5. The composition of claim 4 wherein the polymer component is present in an amount between 1.25% to 2.00% by weight of the combined weight of said polymer component and said organic material.

6. The composition of claim 1 wherein said organic material selected from the group consisting of polypropylene, nylon, polyolephan, and polyester.

7. The composition of claim 1 wherein said organic material selected from the group consisting of cellulose, mulch, straw, coconut and excelsior, polypropylene, nylon, polyolephan, polyester and combinations thereof.

8. A method for reducing soil erosion from an area of land comprising the steps:
a) providing a polymer/organic composition consisting essentially of a polymer component comprising linear polyacrylamide and sodium acrylate and an organic material selected from the group consisting of cellulose, mulch, straw, coconut and excelsior, polypropylene, nylon, polyolephan, polyester and combinations thereof wherein the copolymer is present in an amount between 0.25% to 5.00% by weight of the combined weight of said copolymer and said organic material;
b) applying said polymer/organic composition to said area of land; and
c) hydrating said polymer/organic composition applied in step b).

9. The method of claim 8 wherein in step a), the polymer component is present in an amount between 1.25% to 3.5% by weight of the combined weight of said polymer component and said organic material.

10. The method of claim 8 wherein in step a), the polymer component is present in an amount between 1.25% to 2.00% by weight of the combined weight of said polymer component and said organic material.

11. The method of claim 8 wherein in step c), said hydration step comprises irrigating said polymer/organic composition applied in step b).

12. The method of claim 8 wherein in step c), said hydration step comprises allowing precipitation from rainfall to contact said polymer/organic composition applied in step b).

13. The composition of claim 1 wherein said polymer component further includes a second polymer selected from the group consisting of polyethylene glycol, methylcellulose and hydroxypropylmethylcellulose.

14. The composition of claim 13 wherein said second polymer comprises hydroxypropylmethylcellulose.

15. The method of claim 8 wherein in step a) said polymer component comprises a second polymer selected from the group consisting of polyethylene glycol, methylcellulose and hydroxypropylmethylcellulose.

16. The method of claim 15 wherein said second polymer is hydroxypropylmethylcellulose.

17. The composition of claim 14 wherein said polymer component further comprises glycerin.

18. The method of claim 16 wherein in step a) said polymer component further comprises glycerin.
